(19) United States
(12) Patent Application Publication
(10) Pub. No.: US 2021/0106968 A1
(43) Pub. Date: Apr. 15, 2021

(54) METHOD FOR GENERATION OF NOVEL MATERIALS USING NANOSECOND-PULSED DISCHARGE PLASMA IN LIQUID PHASE

(71) Applicant: DREXEL UNIVERSITY, Philadelphia, PA (US)

(72) Inventors: Danil V. Dobrynin, Philadelphia, PA (US); Alexander Fridman, Philadelphia, PA (US)

(73) Assignee: DREXEL UNIVERSITY, Philadelphia, PA (US)

(21) Appl. No.: 16/922,709

(22) Filed: Jul. 7, 2020

Related U.S. Application Data
(60) Provisional application No. 62/871,502, filed on Jul. 8, 2019.

(51) Int. Cl. B01J 19/08; C01B 21/08; C01B 32/50

(52) U.S. Cl. CPC B01J 19/088; C01B 21/08; C01P 2002/82; C01P 2002/70; C01B 32/50

(57) ABSTRACT

A method for generation of material in a liquid phase comprising a step of subjecting the liquid phase to a nanosecond-pulsed discharge plasma.

### CROSS REFERENCE TO RELATED APPLICATIONS

The application claims the benefit of U.S. Provisional Application No. 62/871,502, filed on Jul. 8, 2019, the entire disclosure of which is hereby incorporated by reference as if set forth fully herein.

### STATEMENT OF GOVERNMENT INTEREST

This invention was made with government support under Contract Number W911NF-17-1-0597 awarded by the Army Research Office. The Government has certain rights in the invention.

### BACKGROUND

Plasma is best known as a gas phase phenomenon. Strong electric fields applied in liquids (water, oils and other organic liquids) have been studied for various applications in chemistry, biology and physics, for example, water sterilization and high power switching. Generally, electrical discharges observed in liquids are either corona or corona-like discharges, pulsed arcs or sparks. In all cases, the discharge is initiated in a gas phase due to local heating of liquid with formation of a gas bubble. Currently the discharge formation mechanism through gas bubble or void formation in the liquid is generally accepted. Two different mechanisms of bubble formation are considered: liquid evaporation due to Joule heating and electrostatic expansion.

Recent advances in pulsed power technology permitted application of much faster voltage rise times (including in the sub-nanosecond range) and revealed that plasma-like phenomena can, in fact, occur in the fluid phase quasi-homogeneously without any bubbles and voids. Extensive analytical and experimental studies have shown that the discharge initiation mechanism is determined by the so-called electrostriction phenomenon which causes formation of a region saturated with nanopores providing necessary space for electrons to gain energy leading to generation of secondary electrons. Very sharp rise times lead to overvoltage and development of a non-thermal discharge (direct ionization of liquid phase) before fluid moves forming bubbles or gas voids. Unique non-equilibrium properties of nanosecond-pulsed cold liquid plasma in homogeneous high-density medium, such as high densities of electrons and excited species, light and high energy radiation, and high electron energies, together with a low temperature of the liquid may provide new opportunities that may lead to fundamentally new effects and may have an impact in the fields of medicine, microelectronics, energy systems and materials.

Nitrogen, under extreme conditions, can form singly-bonded polymeric molecules. Back-conversion of this singly-bonded material into nitrogen's diatomic state would result in a large energy release. Several forms of polymeric nitrogen were discovered and synthesized. At very high pressures nitrogen materials such as a three-dimensional crystalline material or a disordered network of singly-bonded nitrogen atoms have been formed. Unfortunately, pressures on the order of tens of GPa are needed to synthesize nitrogen polymers, and thus this prevents practical application of these materials. Also, there is a lack of recoverable pathways to ambient conditions for these systems. Theoretical quantum mechanical calculations predict that polymeric or amorphous structures would quickly decompose at ambient conditions to form diatomic molecules.

Electrical discharges in liquid have been used extensively for generation of nanostructured materials (see, for example, [1-3]). Nanosecond-pulse spark discharges in liquids, including liquid nitrogen, have also been shown to be reproducible with repeatability of the produced materials [4, 5]. Material synthesis in the case of in-liquid spark discharge is often based on a material of electrodes that undergo erosion during the discharge ignition [6]. In-liquid discharges are an attractive tool for material synthesis due to a unique set of characteristics: relatively high temperature and pressure, radiation (UV, visible and IR range) and high densities of reactive species [7-12]. Ignition of these types of discharges in a cryogenic environment presents new possibilities for generation of unconventional materials, due to the extremely fast quenching by the cryogenic environment outside of the discharge zone.

Novel energetic materials based on nitrogen, e.g. polymeric nitrogen, are of interest as an efficient and clean fuel, for explosives and for energy storage [13]. An all-nitrogen material, however, was shown to be difficult to synthesize (for example, cubic gauche polynitrogen synthesis requires pressures of up to 120 GPa and temperatures of ˜2000 K [14]), and almost impossible to stabilize at normal conditions. Precursor compounds for synthesis of polynitrogens using radiation or pressure effects include metal azides such as sodium azide (NaN₃) [15-19]. It was shown, for example, that polynitrogen material can be produced from NaN₃ at significantly lower initial pressures than were required in other methods for synthesis of polynitrogens by using X-ray and UV irradiation. However back-transformation occurs with material decompression [15].

The present invention relates to treatment of sodium azide using nanosecond-pulsed spark discharge plasma in liquid nitrogen. This plasma treatment results in generation of a new compound which was preliminarily identified as N₆ polynitrogen.

Nanosecond-pulsed discharges in liquids have been studied for some time now. Recently, low energy discharges directly in liquids, or streamers (streamer coronas), generated by nanosecond pulsers with deposited energies on the order of a fraction of to a few tens of mJ, were investigated by several groups (see, among others, [29-33]). These plasmas are typically characterized by relatively small sizes (on the order of mm) and high densities (from 10¹⁷ to 10²⁰ cm⁻³, [32, 35, 836]) and are believed to be generated, or at least initiated, directly in the liquid phase before formation of gaseous voids or bubbles [29, 32, 33]. The exact mechanisms of their initiation, however, are still largely unknown. Although spectroscopic measurements of heavy particle temperatures (“gas” temperatures) are extremely difficult for low energy nanosecond-pulsed discharges, especially in the case of water discharges where the emission spectra show a broad-band continuum [32, 36, 35], estimations from —OH emission from the secondary “bubble” phase of the discharge show that the discharge is actually non-thermal (˜100-200 K increase of associated temperature) [37]. This is in contrast with other types of in-liquid discharges, for example, spark discharges, where temperatures are quite high and result in significant electrode erosion, a process which is frequently used for generation of nanoparticles [38].

Compared to water and other dielectric liquids, very few studies are available for the discharge in cryogenic liquids, including liquid nitrogen. These manuscripts (and references therein) report on the discharge development using high-speed photography and shadow imaging [39-41], evaluation of the ionization rates and reduced electric fields compared to discharges in gaseous nitrogen [42], as well as spectroscopic measurements of the discharge parameters (for longer pulses of sub- and microsecond pulse duration) [40].

In the examples, characterization of nanosecond-pulsed discharge in liquid nitrogen is carried out using imaging and estimation of temperatures from spectroscopic measurements. In addition, generation of unstable “energetic” material directly from liquid nitrogen was observed and preliminarily identified as a form of polynitrogen compound. Synthesis of larger polymeric nitrogen compounds, which are expected to be highly energetic, has been successful, for the most part, at extreme conditions of high pressures (a few to tens of GPa) but to polynitrogen compounds have been shown to be unstable upon pressure release (see, for example, [43]). Some other polynitrogen compounds, like N₃⁻, N₄, N₅⁺ and N₅⁻ have been shown to be stable at ambient conditions in the form of salts and compounds with metal [44-47]. Cubic gauche polymeric nitrogen at near ambient conditions was recently synthesized from a sodium azide precursor inside of nanostubes using radio frequency plasma [20]. Electrochemically, a N₈⁻ was successfully synthesized and stabilized at normal conditions using positively charged nanotubes [49]. In 2001, a black solid substance identified as a non-molecular solid amorphous nitrogen was obtained in compression experiments [50]. Unfortunately, until now, polynitrogen materials produced in high pressure environment have not been recoverable to ambient conditions, which prevents their practical applications.

The present inventors have found that plasma discharge in liquids can be used for generation of polynitrogen (non-molecular) nitrogen compounds. A combination of effective energy transformation from electric fields with increased cavitation pressure waves and a high density of liquid plasma result in efficient synthesis of polymeric nitrogen, but also allow stabilization of the product at cryogenic conditions by, for example, quickly quenching the product.

Other materials that can be produced by this method are polymeric carbon monoxide (another high energy density material) and C₃N₄, a theoretically predicted material with a hardness higher than diamond.

### SUMMARY OF THE INVENTION

In a first aspect, the present invention relates to a method for generation of material in a liquid phase comprising a step of subjecting the liquid phase to a nanosecond-pulsed discharge plasma.

In the foregoing method, the liquid phase may comprise more than 50 wt % of liquid nitrogen.

In each of the foregoing methods, a solid phase may be present in the liquid phase and both of said solid and liquid phases are subjected to the nanosecond-pulsed discharge plasma.

In each of the foregoing methods, the material that is generated may be selected from the group consisting of neutral or ionic polymeric nitrogen, polymeric carbon monoxide and C₃N₄.

In each of the foregoing methods, the solid phase may comprise an azide such as sodium azide.

In each of the foregoing methods, the discharge plasma may be a spark discharge.

In each of the foregoing methods, the pulses may be generated using a high voltage plasma source.

In each of the foregoing methods, the pulses may have an amplitude of 1-50 kV and may be used to ignite a spark discharge.

In the foregoing method, the pulses may be delivered from a power supply to a discharge gap between electrodes in contact with the liquid phase in a manner whereby the duration of the pulse is longer than the time it takes to propagate the pulse from the power supply to the discharge gap; or the pulses may be delivered from a power supply via a cable to a discharge chamber in a manner whereby there is an impedance mismatch between the discharge chamber and the cable and an impedance mismatch between the cable and the power supply.

### BRIEF DESCRIPTION OF THE DRAWINGS

FIG. 1 shows a schematic diagram of an experimental setup for generation of a spark discharge in liquid nitrogen.

FIG. 2A shows current and voltage waveforms of spark discharges in liquid nitrogen ignited using the 30 m “long” high voltage cable for delivery of nanosecond pulses to the electrodes.

FIG. 2B shows current and voltage waveforms of spark discharges in liquid nitrogen ignited using the 3 m “short” high voltage cable for delivery of nanosecond pulses to the electrodes.

FIG. 3A shows an optical emission spectra of spark discharges in liquid nitrogen ignited using the 30 m “long” high voltage cable for delivery of nanosecond pulses to the electrodes.

FIG. 3B shows an optical emission spectra of spark discharges in liquid nitrogen ignited using the 3 m “short” high voltage cable for delivery of nanosecond pulses to the electrodes.

FIG. 4 shows Fourier-Transform Infrared Spectroscopy (FTIR) spectra of untreated NaN₃ and NaN₃ treated with nanosecond-pulsed spark plasma in liquid nitrogen.

FIG. 5A shows Raman spectra of untreated NaN₃ and NaN₃ treated with spark discharge in liquid nitrogen (two separate experiments are shown).

FIG. 5B shows the change of intensity ratio of the new 1660 cm⁻¹ peak to a 1369 cm⁻¹ azide peak with increasing temperature of the treated sample (two separate experiments are shown).

FIG. 6 shows X-ray diffraction spectra of liquid nitrogen treated with spark plasma and untreated NaN₃.

FIG. 7 shows a schematic of an experimental setup for generation of nanosecond-pulsed discharge in liquid nitrogen.

FIG. 8 shows a typical high voltage pulse waveform generated by a FPG 120-01NM10 nanosecond-pulsed power supply and measured using high voltage probe.

FIG. 9 shows the high voltage needle and long exposure Intensified Charge-Coupled Device (ICCD) images (false colored) of the nanosecond-pulsed discharge in liquid nitrogen. Exposure time was 5 ns and the time delay between the pulses was 5 ns. The time stamp corresponds to the arrival of the high voltage pulse at the discharge gap. The white bar is a 1 mm long scale.

FIG. 10 shows shadow imaging of the nanosecond-pulsed discharge in liquid nitrogen showing ignition in the liquid phase and formation of gaseous voids after the main discharge pulse.

FIG. 11A shows emission spectra of the nanosecond-pulsed discharge in liquid nitrogen over the 300-415 nm range integral (100 ns exposure time, single accumulation) emission.

FIG. 11B shows a comparison of an experimental and a Specair [29] simulated spectral line for a 100 ns exposure time.

FIG. 11C shows a time-resolved 337 nm line emission (3 ns exposure, 50 accumulations).

FIG. 11D shows a liquid nitrogen rotational temperature evolution as a function of time obtained from Specair [29] simulations.

FIG. 12A shows a high voltage electrode before and after 1-hour treatment of liquid nitrogen at 60 Hz pulse repetition frequency.

FIG. 12B shows a black powder material that was produced after a 1-hour treatment and after evaporation of excess liquid nitrogen.

FIGS. 13A-13B show Raman spectra of the produced material: overview and nitrogen vibrons in the 2300-2400 cm⁻¹ range.

FIG. 14 shows FTIR spectra of gaseous products of the plasma-produced material after evaporation in helium flow and reaction products of material heating in an air flow (spectra are shifted vertically for clarity).

### DETAILED DESCRIPTION

The present disclosure is directed to the application of plasma for synthesis of polymeric nitrogen compounds, such as, for example, as neutral or ionic N₆. In some embodiments, the polymeric nitrogen compounds are synthesized from a sodium azide precursor. Nanosecond-pulsed plasma ignited in liquid nitrogen is a unique tool for synthesis of unconventional materials due to the combination of energetic properties of the discharge (high densities of reactive species, pressures and radiation) with the low temperature of the surrounding dense liquid

In another aspect, the present invention relates to plasma-generated materials from liquid nitrogen, such as polynitrogen compounds. Nanosecond-pulsed discharge in liquid nitrogen ignited using a needle electrode and positive 60 kV high voltage pulses was characterized using fast and shadow imaging, as well as optical emission spectroscopy. Estimation of temperature was accomplished using molecular nitrogen emission of second positive system rotational-vibrational transition spectra, and the maximum temperature increase was estimated to be ˜60 K.

1. Experimental Setup for Generation of Nanosecond-Pulsed Plasma and Treatment of NaN₃ in in Liquid Nitrogen

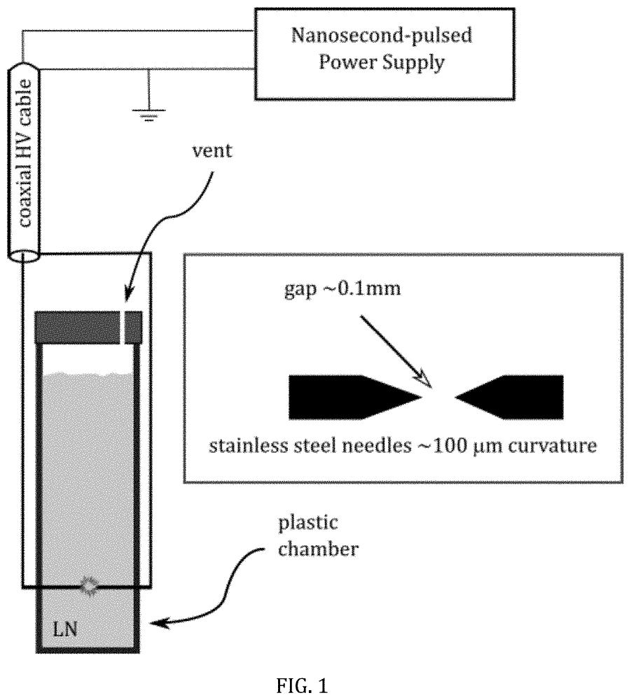

For generation of a spark discharge in liquid nitrogen, two stainless-steel needles with ˜100 μm tip curvature were fixed with a ˜0.1 mm gap in a plastic (50 ml) chamber covered with a lid (FIG. 1). High voltage pulses were generated using a 20-01NK high voltage plasma source (FID Tech Company) capable of providing pulses with a maximum amplitude of 23.7 kV and a duration (63% amplitude) of 12.5 ns. In these experiments, the spark discharge was ignited with 20 kV amplitude pulses. High voltage pulses were delivered to the electrodes via either a 30 m or 3 m long RG 393/U 50 Ohm high voltage coaxial cable. Pulse shape monitoring, and voltage measurements were done using a calibrated back current shunt mounted on the long cable and P6015A high-voltage probe (75-MHz bandwidth, Tektronix). Discharge current was measured using a current monitor (6585, Pearson Electronics Inc.) connected to a digital phosphor oscilloscope (DPO 4104B, Tektronix).

The medical grade (99% N₂, O₂ not more than 1.0%, CO₂<0.001%) liquid nitrogen used in all experiments was purchased from Airgas, USA. Approximately 1 g of sodium azide (>99%, powder, Fisher Scientific) was treated in liquid nitrogen using the spark discharge setup. Sodium azide does not dissolve in liquid nitrogen and thus remains in the form of powder on the bottom of the holding vessel.

A discharge emission spectrum was obtained using a Princeton Instruments-Acton Research TriVista TR555 spectrometer system via a 1 m single leg fiber optic bundle with nineteen 200 μm fibers (190-1100 nm, Princeton Instruments, USA) and a Princeton Instruments PIMAX ICCD camera was used for light registration. The same spectrometer was used in combination with SDM532-100SM-L 532 nm Spectrum Stabilized Laser Module (Newport) and RPB532 Raman probe (InPhotonics) for measurements of Raman spectra. Raman spectra were registered from both the treated and untreated samples directly in liquid nitrogen in a few mm thick liquid layer (in low form Dewar flask, CG-1592-03, Chemglass Life Sciences, USA). Raman spectra of heated samples were obtained in ambient air—treated azide was placed in a covered glass Petri dish (to avoid water condensation on the sample) and allowed to warm up to approximately −8° C. FTIR measurements were performed using a Nicolet 8700 FTIR spectrometer. For measurements of the infrared absorption spectra, treated samples were placed between KBr windows (25×4 mm, Pike Technologies, USA) that were cooled in liquid nitrogen using a cooled sample holder (Universal Sample Holder, Thermo Scientific, USA). Measurements were carried out in a nitrogen atmosphere to avoid water condensation on the windows and within a minute after placement of the sample into the measurement compartment of the spectrometer such that the corresponding temperature increase of the windows and the sample holder was less than ˜50 K as measured by thermocouple.

The X-ray diffraction pattern was collected using a Rigaku SmartLab X-Ray diffractometer (Cu_{Kα}=1.54 Å). Specifically; the sample holder was cooled in liquid nitrogen and the spectra were collected in several steps to minimize sample heating (portions of the same treated sample were used).

2. Results and Discussion

Spark Discharge in Liquid Nitrogen Ignition and Characterization

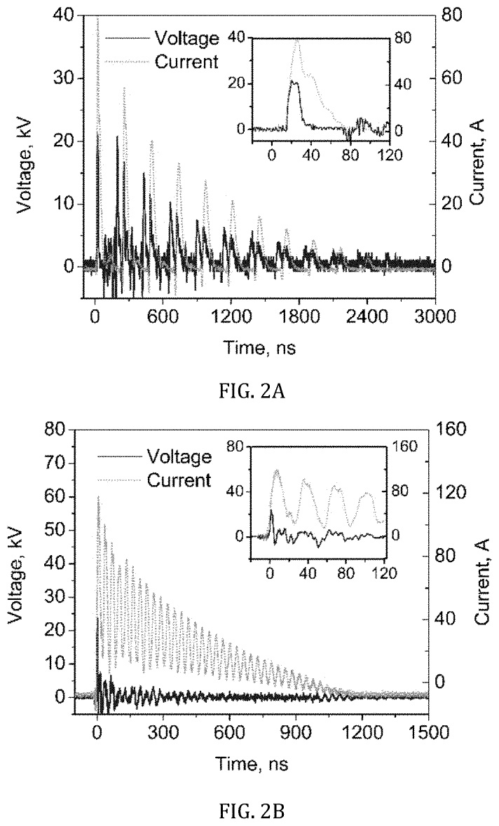

A nanosecond-pulsed spark discharge in liquid nitrogen was ignited using both of the long and short cables to deliver the high voltage pulses from the power supply to the electrodes. The longer cable delivered high voltage pulses to the electrodes with approximately the same shape (rise time and duration) and amplitude as generated by the power supply. The discharge was ignited several times as the pulses were traveling along the cable due to the mismatch of impedance between the discharge chamber and cable as well as the mismatch between the cable and the power supply. These pulse reflections were clearly seen on the oscillogram obtained using the back current shunt (FIGS. 2A-2B). The first voltage pulse was the one that traveled from the high voltage power supply to the electrode (and resulted in the discharge ignition). The second voltage pulse was the reflected one that traveled from the discharge gap back to the power supply (hence, no current peak was seen on the current waveform). In this case, the discharge ignited several times, but a portion of the energy was lost in the cable. The total energy of the the discharges ignited within one sequence was ˜58 mJ, with the energy of the 1^{st} discharge being ˜17 mJ. In contrast, sparks generated using the shorter high voltage cable were ignited as longer (almost 1 μs long) and hotter plasmas, because the duration of the high voltage pulse was longer than it takes it to propagate from the power supply to the discharge gap (it takes ˜14 ns for a signal to travel along a 3 m cable). In this case, the entire length of the cable was essentially at the same potential and acted as a capacitive element with a capacitance of ˜300 pF, which resulted in a characteristic current waveform. The total discharge energy measured was ˜43 mJ.

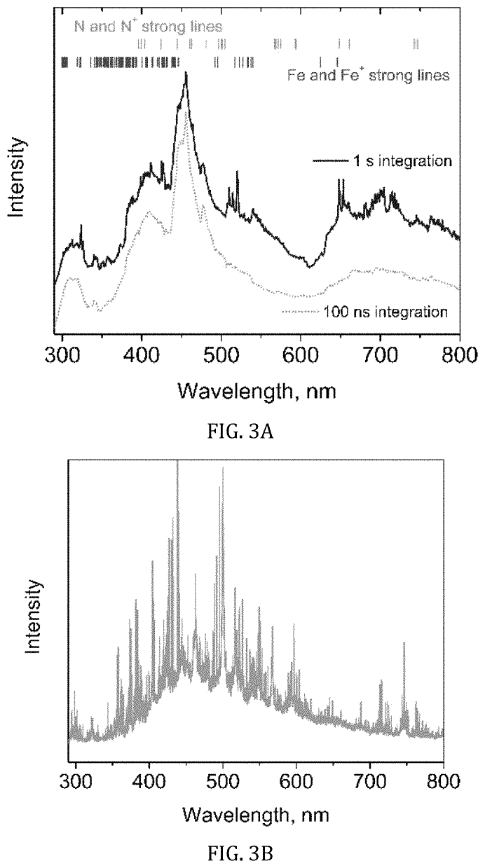

Optical emission spectra of the discharges ignited via the long and short cables showed significant differences (FIGS. 3A-3B). All spectra were obtained using 10 signal accumulations with the discharge running at a 30 Hz repetition frequency. In the case of the long cable, the spectrum of the first discharge ignition (first pulse) recorded with 100 ns exposure time, besides intense broadband background emission, showed only lines of atomic nitrogen and nitrogen ion. With a longer integration time of 1 s, the emission spectrum from the whole discharge could be recorded, including its multiple reignitions due to the pulse reflections. In this case, the appearance of additional metal lines originating from the electrode material was observed. This is an indication that the discharge may have been ignited inside of nitrogen bubbles, and that successive ignitions resulted in evaporation of the electrode material, i.e. electrode erosion and appearance of metal lines in the spectrum. This is very similar to what was observed previously for nanosecond-pulsed discharges ignited in liquid nitrogen, where the authors observed metal melting after ˜100-300 ns after the first discharge initiation. In contrast, the spectrum of the discharge ignited using the short cable (10 ms integration time) was densely populated with atomic metal lines, which confirmed its thermal nature due to the much longer discharge duration and, consequently, higher temperatures and concentrations of the metal material melted from the electrodes. In this case, significant electrode erosion was observed, e.g. after 30 minutes stainless steel high voltage electrode erosion caused a shortening of ˜300 μm with a corresponding weight decrease of 0.4 mg. The grounded electrode shortened by ˜800 μm and a ˜0.8 mg decrease of weight was observed.

Treatment of NaN₃ in Liquid Nitrogen Using Spark Discharge

Approximately 1 g of sodium azide (>99%, powder, Fisher Scientific) was added to the liquid nitrogen before treatment. Treatments were done using both higher and lower energy discharge systems with a 200 Hz pulse repetition frequency. No significant differences in the appearance and of the treated sodium azide were observed indicating that the effects of the electrode erosion and the discharge temperature likely did not play a major role in the sodium azide transformations. The results reported below were obtained for the higher energy discharge, After ˜5-10 min of treatment, the NaN₃ powder changes color from white to green, and if left in ambient air, treated samples turn yellow as they absorb water. The initial color change (from white to green) indicates a structural change of the sodium azide following plasma treatment in liquid nitrogen.

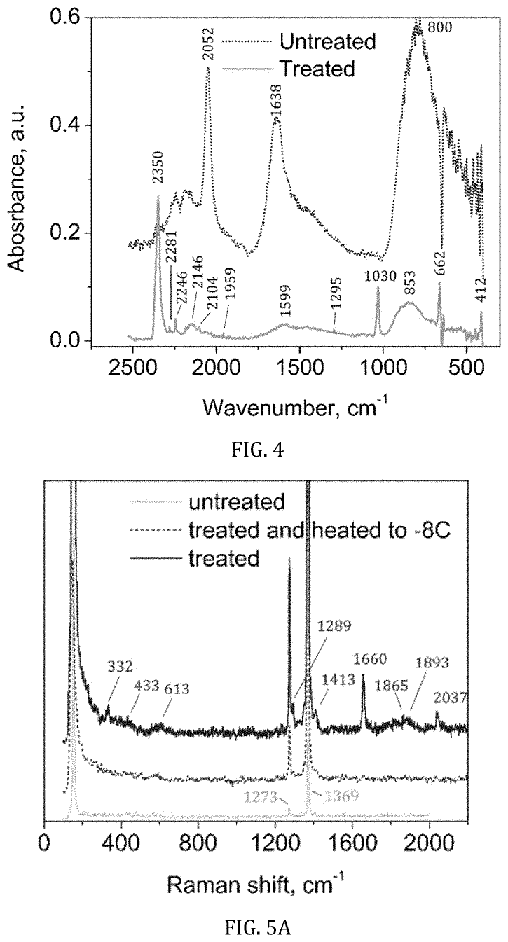

The IR spectrum of both the treated and untreated samples shown in FIG. 4. Typical NaN₃ IR lines at around 800, 1630 and 2050 cm⁻¹ were detected for the untreated sample. After the plasma treatment, a number of new peaks appear, and the new peaks at 2350 cm⁻¹ and 1030 cm⁻¹ are especially strong. The 2350 cm⁻¹ peak (together with the much weaker 2281 cm⁻¹ and 662 cm⁻¹ peaks) probably originate from solid. CO₂ [20] which is present in liquid nitrogen as an impurity. The peak at 1030 cm⁻¹ is close to the absorption band v₃ of ozone. However, no other vibrational ozone bands were registered at around 1100 and 700 cm⁻¹ (v₁ and v₂ respectively) [1-24], The experimental IR absorption spectrum was compared to the IR vibrational frequencies of polynitrogen molecules predicted by R. Bartlett and colleagues [25]. A strong band at around 1030 cm⁻¹ was predicted for a number of polynitrogen molecules. However, the combination of the observed lines matches best with the predictions for N₆⁺ ions (Table 1) [26, 27].

TABLE 1
List of predicted IR vibrational frequencies of N₆
molecules [24] compared to observed lines in this study

| Molecule | IR frequency | Intensity | IR frequency | |
|---|---|---|---|---|
| structure | calculation, cm⁻¹ | calculation | observed, cm⁻¹ | Notes |
| N₆⁺ C₂ₕ planar ²B_{g} | 448.2 | 3.5 | 447 | Weak |
| | 584 | 12.6 | 533 | weak |
| | 1036 | 112 | 1030 | Strong |
| | 2191.8 | 206 | 2185 | Weak |
| | | | 2146 | Broad |
| N₆⁺ C₂ᵥ planar ²B_{g} | 530.7 | 0.5 | 533 | Weak |
| | 769.1 | 46.4 | 853 | Broad |
| | 840.9 | 35 | | |
| | 844.6 | 12.8 | | |
| | 1281.6 | 0.7 | 1295 | Weak |
| | 2138.7 | 54.1 | 2146 | Broad |
| | 2189.5 | 35.3 | 2184 | Weak |
| N₆⁻ Cₛ ²A′ | 415.2 | 4.8 | 412 | |
| | 511.3 | 5.6 | 511 | Weak |
| | 661.4 | 109 | 662 | Strong |
| | 882.4 | 32.9 | 853 | Broad |
| | 1016.3 | 192.9 | 1030 | Strong |
| | 1283.2 | 11 | 1298 | Weak |
| | 1636.8 | 390.5 | 1599 | Broad |
| | 2145.5 | 936 | 2146 | Broad |

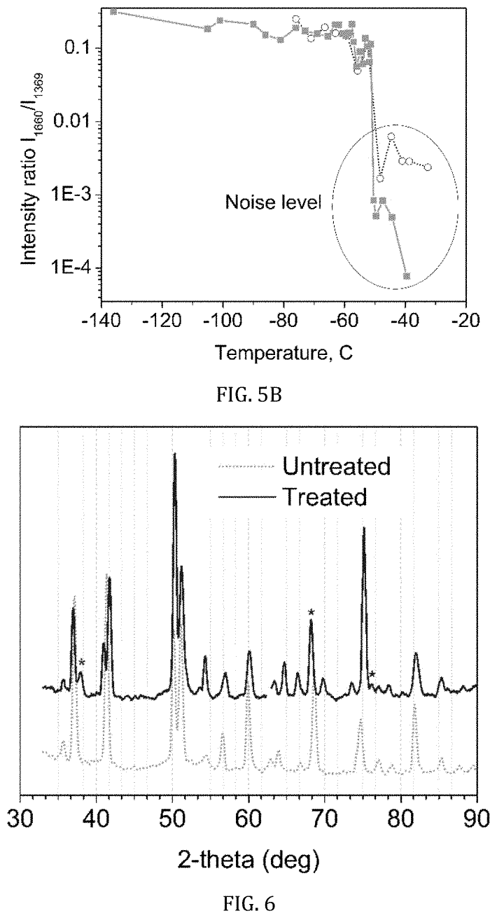

Raman spectra of untreated azide, treated azide and treated azide heated to −8° C. show characteristic NaN₃ peaks at 1273 cm⁻¹ and 1369 cm⁻¹ (FIGS. 5A-5B). After treatment, additional peaks appear in the Raman spectrum similar to the spectrum of azide treated with X-ray and UV at elevated pressures [15]. No Raman peaks for ozone were registered in these experiments. Numerical calculations for Raman vibrational frequencies for N₆⁻ ions predict strong Raman peaks at around 1283 cm⁻¹ and 1636 cm⁻¹, as well as other vibrational bands of N₆ molecules close to the observed ones (although predicted intensities are low). Following analysis in [17]:
Peak at ˜1660 cm⁻¹ can probably be assigned to vₛ(N═N)
The intensity enhancement of the v_{b}(N₃) modes at around 610 cm⁻¹ (at higher pressures in the cited study ˜640 cm⁻¹) could indicate the change in linear N═N=N to bent N═N—N.

We have followed the peak at 1660 cm⁻¹ as a function of the temperature of the treated azide. The result (compared to the relatively constant intensity of 1369 cm⁻¹ peak) showed disappearance of the 1660 cm⁻¹ peak at around −55° C., which could indicate that the obtained material is stable up to this temperature at ambient pressure conditions.

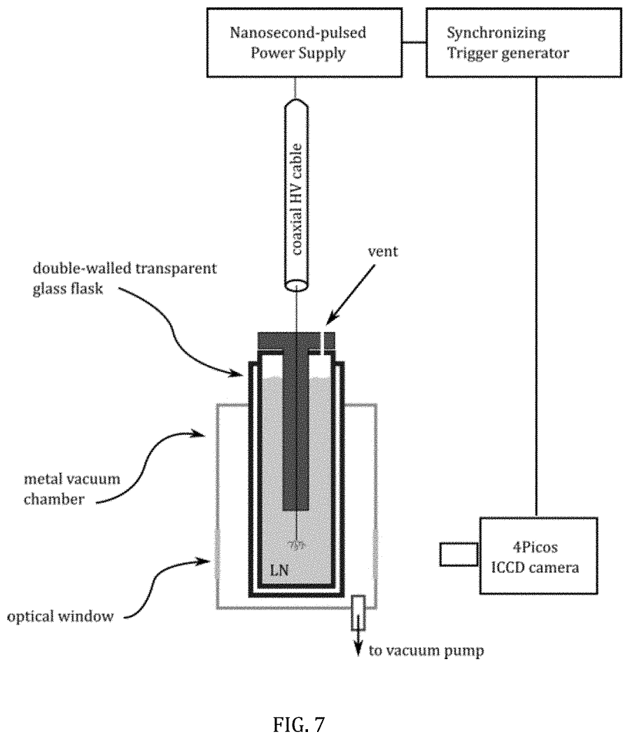

The X-ray diffraction pattern (FIG. 6) is compared to the XRD data from [27] obtained using the same λ˜1.54 Å (and compared to that for λ=0.41686 Å employed by Eremets et al. [14]). The lines indicated by peaks at 37, 66 and 77 2θ degrees correspond closely to the (110), (211) and (220) reflections of the cubic gauche structure of polymeric nitrogen reported by Eremets and co-workers. The strong lines correspond to unreacted NaN₃. Our results also show peaks at 38 (new compared to untreated), 68 (new or shifted 0.5 degree compared to untreated) and 76 2θ degrees. In addition, the peak at 41.3° splits into two new peaks at 40.9° and 41.7°; a new peak appears at 73.4°; the peaks at 37.1, 68.7, 78.8 appear shifted to negatively by ˜0.5° to 36.9, 68.2 and 78.2 and, correspondingly; peaks at 50.1, 56.6, 60, 63.9, 74.7 and 81.8 are positively shifted to 50.3, 57, 60.2, 64.6, 75.1 and 85.3°.

Overall, the experimental observations support that liquid nitrogen spark discharge plasma induces transformations in sodium azide, and likely results in formation of polynitrogen materials, most probably neutral or ionic N₆. The produced material is probably stable up to a temperature of about −55° C. at ambient pressure. The mechanism behind the reaction products could be related to the effects of plasma radiation (for example, UV radiolysis and UV absorption). Indeed, it was suggested that two-photon absorption could produce azide radicals and ultimately N₆⁻ ions in reactions like:

N₃⁻+hv→N*₃+e⁻ and N₃⁻+N₃*→N₆⁻ [15].

As no differences in the azide transformation between the plasma regimes (“high energy” vs “low energy”), the mechanism is likely related to the effects of plasma radiation in the UV range and possibly excited nitrogen and is not related to the electrode erosion and the discharge temperature. It is possible that liquid nitrogen spark discharge also results in generation of iron nitride compounds (for example, FeN₂) that are linked to formation of double bonded Na species as well [28].

Using different lengths of the high voltage cable, it is possible to generate spark discharges with different durations and energies (and expected temperatures). These discharges were used for treatment of sodium azide in liquid nitrogen. Experimental characterization techniques showed that plasma treatment of NaN₃ results in production of colored material with spectral characteristics close to N₆ polynitrogen compounds, although it is most likely is a mixture of different compounds. The obtained material appears to be stable at ambient pressure at temperatures up to around −55° C.

### REFERENCES

The following references may be useful in understanding some of the principles discussed herein:
1. W G Graham and K R Stalder 2011 Plasmas in liquids and some of their applications in nanoscience J. Phys. D: Appl. Phys. 44 174037
2. T Belmonte et al 2014 Interaction of discharges with electrode surfaces in dielectric liquids: application to nanoparticle synthesis J. Phys. D: Appl. Phys. 47 224016
3. N I Kuskova et al 2007 Obtaining nanocarbon using the electric-discharge treatment method of organic liquids. Surface Engineering and Applied Electrochemistry, 43(4), 269-275.
4. T Belmonte et al 2018 Analysis of Zn I emission lines observed during a spark discharge in liquid nitrogen for zinc nanosheet synthesis Plasma Sources Sci. Technol. 27 074004
5. A Hamdan et al 2018 Synthesis of two-dimensional lead sheets by spark discharge in liquid nitrogen Particuology 40 pp 152-159
6. D V Schur et al. 2007 Production of carbon nanostructures by arc synthesis in the liquid phase Carbon, 45 (6) pp. 1322-1329
7. G Touya et al 2006 Development of subsonic electrical discharges in water and measurements of the associated pressure waves J. Phys. D: Appl. Phys. 39 5236
8. Šimek M, Pongrác B, Babický V, Člupek M and Lukeš P 2017 Luminous phase of nanosecond discharge in deionized water: morphology, propagation velocity and optical emission Plasma Sources Sci. Technol. 26 07LT01
9. Marinov I, Starikovskaia S and Rousseau A 2014 Dynamics of plasma evolution in a nanosecond underwater discharge J. Phys. Appl. Phys. 47 224017
10. Pongrác B, Šimek M, Člupek M Babický V and Lukeš P 2018 Spectroscopic characteristics of H α/OI atomic lines generated by nanosecond pulsed corona-like discharge in deionized water J. Phys. D: Appl. Phys. 51 124001
11. Marinov I, Guaitella O, Rousseau A and Starikovskaia S M 2013 Modes of underwater discharge propagation in a series of nanosecond successive pulses J. Phys. D: Appl. Phys. 46 464013
12. Dobrynin D, Seepersad Y, Pekker M, Shneider M, Friedman G and Fridman A 2013 Non-equilibrium nanosecond-pulsed plasma generation in the liquid phase (water, PDMS) without bubbles: fast imaging, spectroscopy and leader-type model J. Phys. D: Appl. Phys. 46 105201
13. K Christe 2007 Recent Advances in the Chemistry of N5+, N5− and High-Oxygen Compounds Propellants, Explosives, Pyrotechnics 32 (3) pp 194-204
14. Eremets M I et al 2004 Single-bonded cubic form of nitrogen Nat. Mater., 3, 558-563
15. N Holtgrewe et al 2016 Photochemistry within Compressed Sodium Azide J. Phys. Chem. C, 120, 28176-28185
16. S M Peiris et al 2003 Photolysis of Compressed Sodium Azide (NaN₃) as a Synthetic Pathway to Nitrogen Materials J. Phys. Chem. A, 107, 944-947
17. S Duwal et al 2018 Transformation of hydrazinium azide to molecular N8 at 40 GPa J. Chem. Phys. 148, 134310
18. J Jiang et al 2016 High pressure studies of trimethyltin azide by Raman scattering, IR absorption, and synchrotron X-ray diffraction RSC Adv., 6, 98921
19. H Zhu et al 2013 Pressure-induced series of phase transitions in sodium azide J. Appl. Phys. 113, 033511
20. Isokoski K, Poteet C A and Linnartz H, 2013, Highly resolved infrared spectra of pure CO2 ice (15-75 K), Astronomy and Astrophysics 555 A85
21. L Brewer 1972 Infrared Absorption Spectra of Isotopic Ozone Isolated in Rare-Gas Matrices J. Chem. Phys. 56, 759
22. L. Schriver-Mazzuoli et al 1995 Ozone generation through photolysis of an oxygen matrix at 11 K: Fourier transform infrared spectroscopy identification of the O . . . O3 complex and isotopic studies J. Chem. Phys. 102, 690
23. A Lakhlifi et al 1993 Interpretation of the infrared spectrum of ozone trapped in inert matrices Chem Phys 177 31-44
24. B D Teolis et al 2007 Low density solid ozone J. Chem. Phys. 127, 074507
25. R D Bartlett et al Stable polynitrogen molecules from N₂ to N₁₀ and their anions and cations IR vibrational frequencies and intensities, http://www.qtp.ufl.edu/˜bartlett/downloads/polynitrogen.pdf
26. M Tobita and R J Bartlett 2001 Structure and Stability of N₆ Isomers and Their Spectroscopic Characteristics J. Phys. Chem. A 105 16 4107-4113
27. Benchafia et al 2017 Cubic gauche polymeric nitrogen under ambient conditions, Nature Communications, vol 8, Article number: 930
28. Laniel D, Dewaele A and Garbarino G 2018 High Pressure and High Temperature Synthesis of the Iron Pernitride FeN2, Inorg. Chem. 57 6245-6251

Experimental Setup and Methods

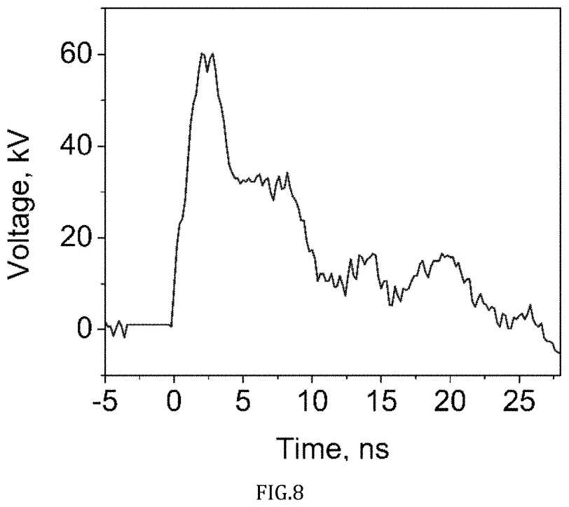

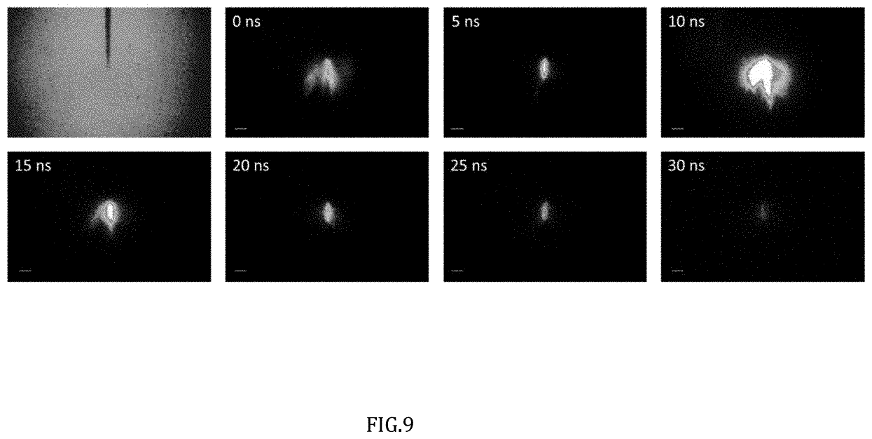

For generation of discharge in liquid nitrogen, a sharp (75 μm radius of curvature) a steel electrode was placed in liquid nitrogen contained in a 450 ml double-walled glass vacuum flask (FIG. 7). The flask was fixed inside of an evacuated metal chamber to decrease the liquid nitrogen evaporation rate and to screen electromagnetic noise. The vacuum flask was also closed at the top by a plastic lid provided with a 3 mm diameter venting hole to minimize liquid nitrogen contamination by the surrounding air, especially oxygen. Medical grade (99% N₂, O₂ not more than 1.0%, CO₂<0.001%) liquid nitrogen was used in all experiments and was purchased from Airgas, USA. The high voltage electrode was powered via a 10 m long 50 Ohm coaxial cable by an FPG 120-01NM10 nanosecond-pulsed power supply (FID Tech., Germany) capable of providing positive high voltage pulses with a maximum pulse amplitude 120 kV, a rise time 10% to 90% amplitude in less than 1 ns, and a pulse duration at 90% amplitude of 8-10 ns. The pulse waveform recorded using the high voltage probe (P6015A, Tektronix, OR, USA) is shown in FIG. 8. However the shape of the pulse is distorted due to the low bandwidth of the high voltage probe and circuit ringing. In most of the experiments the discharge was ignited using HV pulses with an amplitude of 60 kV. The discharge energy was not measured due to the practical difficulty of installing a back current shunt in the high voltage cable system. The voltage is estimated to be about 100-130 mJ based on the energies of similar nanosecond-pulsed discharges in water measured at lower voltages using the back current shunt [37].

Discharge imaging was performed using a 4Picos ICCD camera (Stanford Computer Optics, USA) equipped with a UV lens and synchronized with the power supply using an AFG-3252 function generator (Tektronix, USA). Shadow imaging was carried out using a 30 W/mm Deuterium arc lamp (Newport, USA) as a source of back light. The discharge emission was recorded using a Princeton Instruments-Acton Research, TriVista TR555 spectrometer system via a 1 m single leg fiber optic bundle with nineteen 200 μm fibers (190-1100 nm, Princeton Instruments, USA) and a 4Picos ICCD camera. FTIR measurements were performed using a Nicolet 8700 FTIR spectrometer equipped with a 2 m gas cell with KBr windows and having a 200 ml internal volume (Thermo Fisher Scientific, USA). Raman spectra were obtained using a SDM532-100SM-L 532 nm Spectrum Stabilized Laser Module (Newport, USA) and a TriVista spectrometer system. For that, the excitation fiber of a RPB532 Raman probe (InPhotonics, USA) was connected to the laser source and the emission fiber was connected to the entrance slit of the spectrometer. The Raman probe was positioned at ˜7.5 mm (focal length of the probe) above the examined samples. At the focal point, the probe spot size was approximately 160 μm and depth of field was ˜2.2 mm Spectra were typically recorded with a 1 s exposure time and 10 accumulations. The spectrometer was calibrated using a 6035 Hg(Ar) calibration lamp (Newport).

Results and Discussion

Discharge Imaging

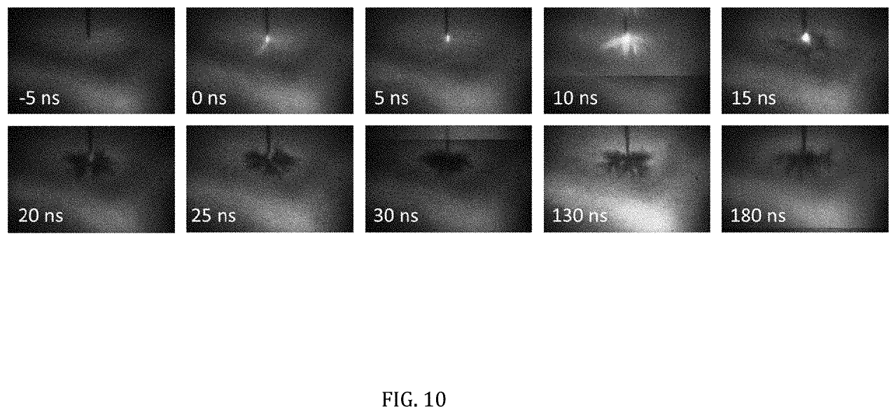

FIG. 9 shows long (5 ns) exposure images of the discharge in liquid nitrogen taken with a 5 ns time step. The discharge was visible using ICCD camera for about 30 ns, and high voltage pulse reflections were absorbed by the power supply. This is in contrast to other studies (see, for example, [32, 37, 55, 56]) where reflected pulses resulted in successive discharge ignitions in the gaseous voids (bubbles).

The typical discharge size was on the order of few mm and appeared to be significantly larger than was reported previously for slower but lower voltage (˜30 kV) pulses applied for generation of a streamer in liquid nitrogen, although in these experiments the electrode size was quite large compared to, for example, the 1 μm needle used in [40]). From these images, streamer propagation velocity was estimated to be at least 0.7±0.8×10³ km/s, using the relatively long exposure time of 5 ns. Previously, similar propagation velocities were reported for discharges in water (see, for example, [29, 33, 56]), however in [40] and [41] streamer propagation velocities in liquid nitrogen were an order of magnitude lower.

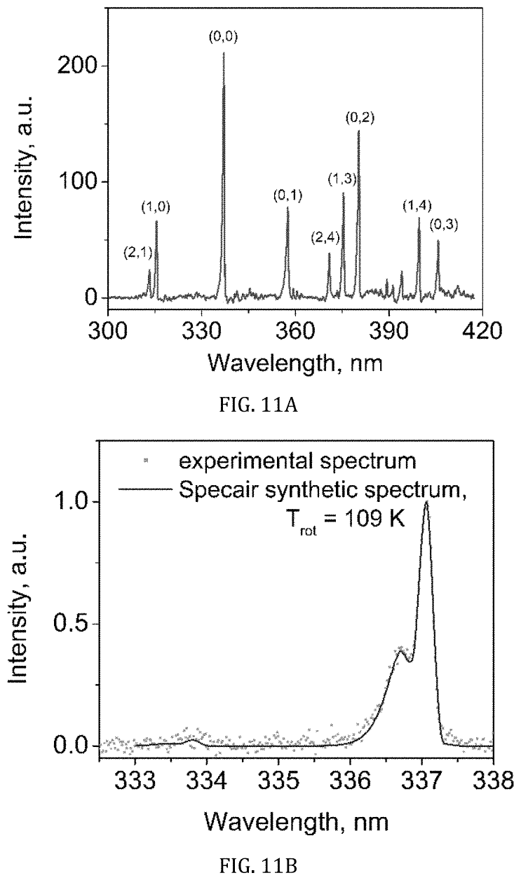

In order to examine whether the discharge is ignited in preexisting gaseous bubbles which could be present from, for example, previous discharge ignitions or evaporation of nitrogen on the needle, shadow imaging of the discharge was carried out. The results (FIG. 10) indicated that no large-scale irregularities existed in the liquid before the discharge, and only after about 15 ns, when the main plasma event started to decay, visible gas voids started to appear at the location of the streamers. This corresponds well with the previous observations for the nanosecond discharge in water [37].

Optical Emission Spectra of the Nanosecond-Pulsed Discharge in Liquid Nitrogen

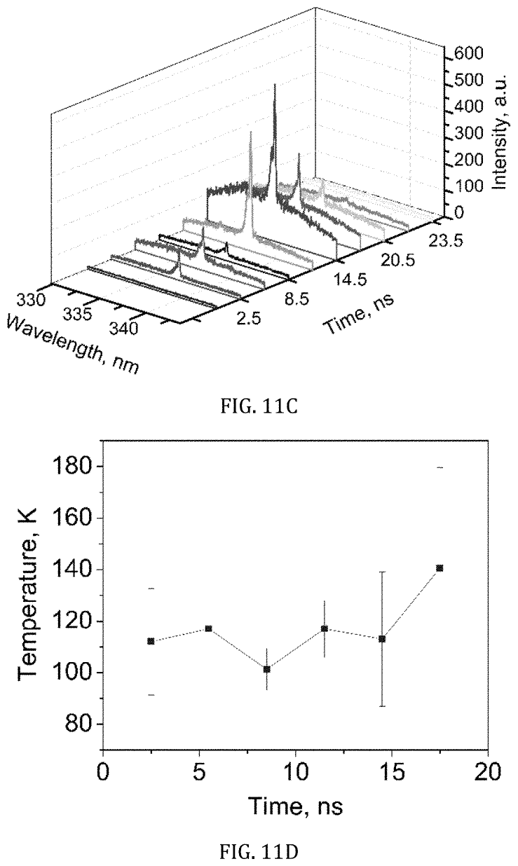

Emissions from the discharge in the 300-415 nm range were recorded using the 4Picos ICCD camera with either a 100 ns exposure time and a single accumulation or a 3 ns exposure time and 50 accumulations. Obtained spectra are shown in FIGS. 11A-11D, where the short exposure time spectra are shown with the time corrected for the light propagation delay in the optical fiber and spectrometer, as compared to the discharge imaging system. The emission spectrum in this range (300-415 nm) is mostly from molecular nitrogen emission lines ˜second positive system C ³Πᵤ-B ³Π_{g} (SPS). The first positive system B ³Π_{g}-A ³Σᵤ⁺ emission was also observed in the 700-900 nm range, as well as some atomic nitrogen emission lines, but due to high noise the data are not shown here.

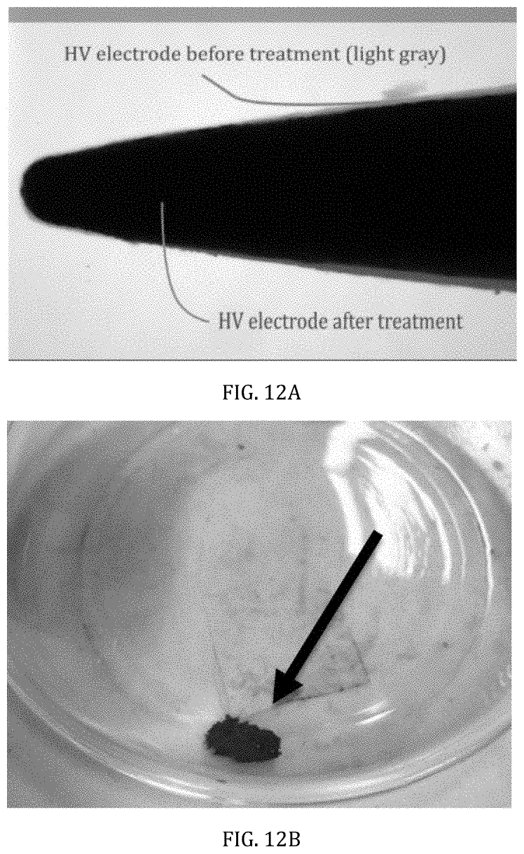

Using the ro-vibrational emission spectrum of the 0-0 C ³Πᵤ-B ³Π_{g} transition (SPS) at around 337 nm and assuming equilibrium of the rotational temperature Tᵣ(C) of the C state and Tᵣ(X) of the ground state of nitrogen, the temperature of the discharge were estimated (FIGS. 11A-11D). The rotational temperature of nitrogen was estimated by fitting a synthetic spectrum to the experimental spectrum of the 337 nm transition emission band of the second positive system of nitrogen with the program Specair 3.0 [29] (FIGS. 11A-11D). Simulation of the long exposure (100 ns) spectrum shown in FIGS. 12A-12B resulted in the estimated temperature value of ˜110 K, and the maximum discharge temperature obtained from the time resolved spectra was about 140 K—about 60 K above the liquid nitrogen temperature. Previously, spectroscopic measurements of nanosecond-pulsed streamers in liquid nitrogen were done for slower, but probably more energetic, pulses and the estimated temperature was ˜500 K [40]. No significant broadening of the emission lines was observed, in contrast to water experiments, which could be interpreted to indicate that the emission originated from the low-density regions.

Nitrogen Material Production by the Nanosecond-Pulsed Discharge in Liquid Nitrogen

Nanosecond-pulsed discharge was used for treatment of liquid nitrogen. The treatment duration was 30-60 minutes at a pulse repetition frequency of 60 Hz. After 60 minutes of treatment, no significant erosion of the high voltage electrode was observed (FIGS. 12A-12B). Liquid nitrogen after 1 hour of treatment (about 50 mL) was heated in room air and in a helium atmosphere (closed vessel) on a hot plate having a temperature of about 400° C.) in order to increase the concentration of the produced material. With evaporation of the liquid nitrogen the liquid darkened leaving a black powder-like material (see FIGS. 12A-12B), and within a second exploded with generation of both light and sound. No residue was left after the explosive material decomposition. The observed material appeared to be very similar to the one described in [50]—a solid amorphous non-molecular form of nitrogen.

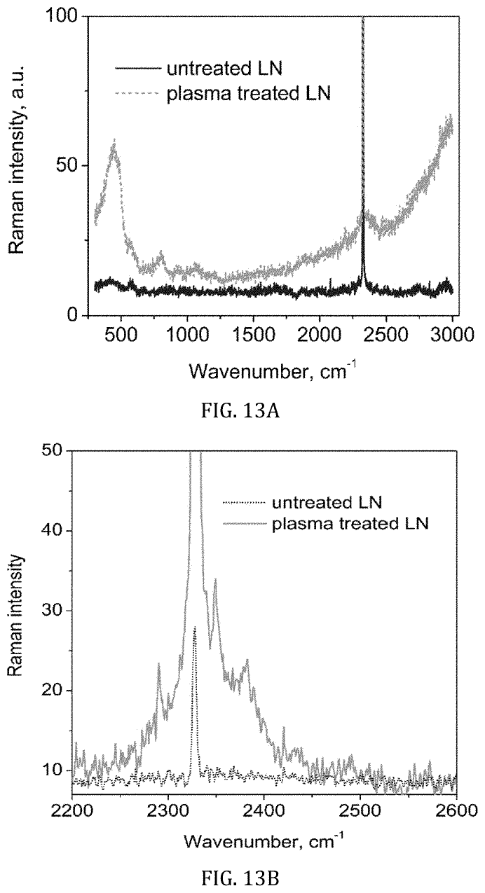

We attempted to measure the Raman spectrum of the obtained material. The Raman spectrum of the liquid nitrogen changes after treatment (FIGS. 13A-13B) but is difficult to interpret. A nitrogen vibron is present at around 2330 cm⁻¹ in both the treated and untreated samples. Similar to [50-54], vibron excitation was observed in the vicinity of the main 2330 cm⁻¹ peak which could indicate appearance of a new phase. Broad features around 800 cm⁻¹, 930 cm⁻¹ and 1050 cm⁻¹ probably could be assigned to N—N modes (e.g., compared to calculations and measurements from [49] where the line at 1060 cm⁻¹ corresponds to the N₈⁻ vibrational frequency) likely broadened due to structural disordering (amorphization). No characteristic lines from azide groups at 1360 cm⁻¹ were observed, nor were any Raman peaks associated with ozone observed, which further supports the liquid nitrogen-based plasma production of energetic nonmolecular form of a nitrogen-rich material.

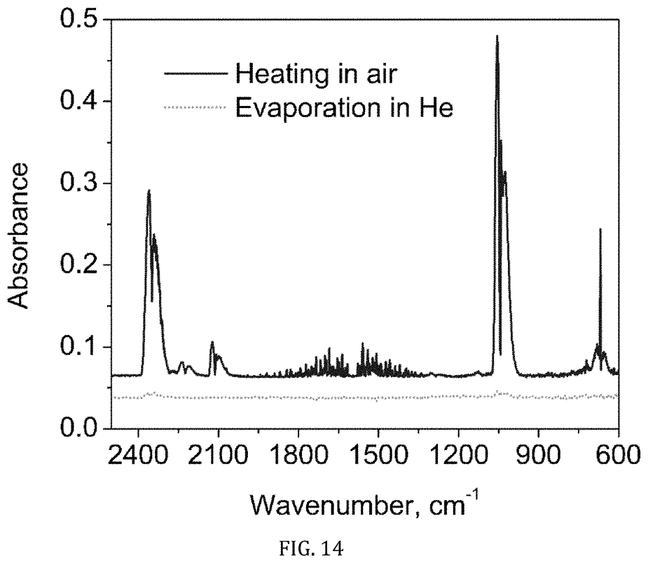

FTIR analysis of the gaseous products of sample evaporation and decomposition in air (explosion) was done using a Nicolet 8700 FTIR spectrometer equipped with a 2 m gas cell. For evaporation product measurements, the samples were placed in a tightly closed reaction vessel with an outlet connected to the spectrometer gas cell; in order to prevent possible reactions with oxygen in the ambient air. Additional helium flow at rate of 1 slpm was supplied into the system. The reaction products of the sample decomposition were examined in the presence of ambient air. For that, the treated sample was placed into a reaction vessel heated using a hot plate, and ambient air was pumped into the reaction vessel at a flow rate of 1 slpm. The representative spectra are shown in FIG. 14.

FTIR spectra of the gaseous products from heated samples show peaks of ozone, N₂O, water and CO₂. Samples evaporated in helium show significantly lower concentrations of ozone and CO₂. The presence of carbon dioxide in the evaporated (unheated) sample is due to its presence in liquid nitrogen and contamination from ambient air. Ozone can be generated in liquid nitrogen during the discharge from the 1% oxygen that is present in the untreated liquid nitrogen, though its concentration is relatively low and is estimated to be only a few ppm. It is, however, unlikely that the presence of ozone and nitrous oxide is the result of their direct generation by the discharge in liquid nitrogen since no other NOₓ species (e.g., NO, NO₂, N₂O₅) were detected that would also be expected to be produced in air plasmas [58]. Moreover, the production of atomic nitrogen in the presence of molecular oxygen and atomic oxygen in the presence of nitrogen immediately leads to generation of NOₓ species. See for example [58]:

N+O₂→NO+O

N+O₃→NO+O₂

O+N(²P)→NO⁺+e

O+NO+M→NO₂+M,M=N₂,O₂,NO,NO₂,N₂O, and others

In contrast, N₂O can be produced in the following reaction [30]:

N₂(A)+O→N₂O+O. (1)

that does not require the availability of NOₓ species. This also results in simultaneous production of ozone:

$$\{ \begin{matrix}{N}_{2} ( A ) + {O}_{2} \to {N}_{2} ( X ) + O + O \\ O + {O}_{2} + M \to {O}_{3} + M\end{matrix} \qquad ( 2 )$$

During heating in the presence of air, the sample rapidly decomposes with generation of large amounts of both ozone and N₂O. In this case, ozone concentrations of up to several percent and N₂O concentrations of ˜0.1-0.5% were observed. This significant increase in both O₃ and N₂O can be explained by a significant energy release during sample decomposition. Due to the absence of NO and other similar species, it appears that one possible mechanism of such rapid production of both nitrous oxide and ozone during the sample decomposition is related to energy release and production of excited nitrogen via reactions (1) and (2). This is somewhat surprising since production of electronically excited nitrogen (triplet sigma nitrogen, N₂ (A³Σᵤ⁺)) requires energies on the order of 6.2 eV and this type of nitrogen is not typically produced during explosions. On the other hand, the N≡N triple bond energy is characterized by a value of 229 kcal/mol (9.9 eV), while the N═N double and N—N single bond energies are only 100 kcal/mol (4.3 eV) and 38 kcal/mol (1.6 eV), respectively. Back conversion to diatomic molecular nitrogen is, therefore, highly exothermic and the corresponding energy release could be the source of production of electronically excited N₂ (A³Σᵤ⁺) which leads to generation of N₂O. Multiple Nₓ all-nitrogen compounds could be formed in the non-thermal plasma in liquid nitrogen. Ions like N₃⁺ could be produced that can further polymerize in reactions like:

N₃⁻+hv→N₃*e⁻ and N₃⁻+N*₃→N₆⁻ [59].

The results can be summarized as follows:
1. Nanosecond-pulsed discharge in liquid nitrogen, much like in water, initially ignites directly in the liquid phase, and the energy release eventually results in generation of gaseous voids.
2. First temperature estimations from the molecular nitrogen emission showed a maximum temperature increase on the order of 60 K, which is advantageous for non-thermal material synthesis in the liquid phase.
3. Production of nitrogen-based material from this discharge was observed, which appears to be a form of an energetic non-molecular nitrogen compound due to the following reasons:
a) no electrode erosion was observed while the amount of produced material was significant;
b) material decomposition, accompanied by light and sound wave generation, was triggered by heating;
c) no residue was left after the material decomposition; and
d) the absence of NOₓ species, except N₂O, in the reaction products as determined by FTIR indicates a low-temperature decomposition mechanism.

The multitude of species that can be formed in plasma, as well as the structural disorientation of the produced material results in complicated Raman spectra that cannot be interpreted with a high degree of certainty or be compared with the large pool of previous data on polynitrogen material production at elevated pressures.

### REFERENCES

The following references may be useful in understanding some of the principles discussed herein:
29. Starikovskiy A, Yang Y, Cho Y 1 and Fridman A 2011 Non-equilibrium plasma in liquid water: dynamics of generation and quenching Plasma Sources Sci. Technol. 20 024003
30. Marinov I, Guaitella O, Rousseau A and Starikovskaia S M 2013 Cavitation in the vicinity of the high-voltage electrode as a key step of nanosecond breakdown in liquids Plasma Sources Sci. Technol. 22 042001
31. Marinov I, Guaitella O, Rousseau A and Starikovskaia S M 2013 Modes of underwater discharge propagation in a series of nanosecond successive pulses J. Phys. D: Appl. Phys. 46 464013
32. Dobrynin D, Seepersad Y, Pekker M, Shneider M, Friedman G and Fridman A 2013 Non-equilibrium nanosecond-pulsed plasma generation in the liquid phase (water, PDMS) without bubbles: fast imaging, spectroscopy and leader-type model J. Phys. D: Appl. Phys. 46 105201
33. Pongrác B, Šimek M, Ondáč P, Člupek M, Babický V and Lukeš P 2019 Velocity of initial propagation of positive nanosecond discharge in liquid water: dependence on high voltage amplitude and water conductivity Plasma Sources Sci. Technol. 28 02LT02
34. Šimek M, Pongrác B, Babický V, Člupek M and Lukeš P 2017 Luminous phase of nanosecond discharge in deionized water: morphology, propagation velocity and optical emission Plasma Sources Sci. Technol. 26 07LT01
35. Marinov I, Starikovskaia S and Rousseau A 2014 Dynamics of plasma evolution in a nanosecond underwater discharge J. Phys. Appl. Phys. 47 224017
36. Pongrác B, Šimek M, Člupek M Babický V and Lukeš P 2018 Spectroscopic characteristics of H α/OI atomic lines generated by nanosecond pulsed corona-like discharge in deionized water J. Phys. D: Appl. Phys. 51 124001
37. Seepersad Y, Nanosecond Pulsed Discharge in Water without Bubbles: A Fundamental Study of Initiation, Propagation and Plasma Characteristics, PhD Thesis, Drexel University, USA
38. Kabbara H, Ghanbaja J, Noel C and Belmonte T 2017 Synthesis of Cu@ZnO core-shell nanoparticles by spark discharges in liquid nitrogen Nano-Structures & Nano-Objects 10 22-29
39. Fleszynski D, Zelek A and O I Skowronski, 1979 Development of discharges in liquid nitrogen in non-uniform electrical field, Journal of Electrostatics, 7 39-46
40. Frayssines P E, Bonifaci N, Denat A and Lesaint O 2002 Streamers in liquid nitrogen: characterization and spectroscopic determination of gaseous filament temperature and electron density J. Phys. D: Appl. Phys. 35 369-77
41. Yamazawa K and H Yamashita 1997 Prebreakdown Density Change Streamer in Liquid Nitrogen Jpn. J. Appl. Phys. 36 6437
42. A A Belevtsev and V V Markovets 2001 Nanosecond breakdown in liquid nitrogen J. Phys. D: Appl. Phys. 34 L52
43. Eremets M I, Gavriliuk A G, Trojan I A, Dzivenko D A and Boehler R 2004 Single-bonded cubic form of nitrogen Nat. Mater., 3, 558-563
44. Christe, K. O., Wilson, W. W., Sheehy, J. A. and Boatz, J. A. 1999 N₅⁺: A Novel Homoleptic Polynitrogen Ion as a High Energy Density Material. Angewandte Chemie International Edition, 38: 2004-2009
45. Steele B, Stavrou E, Crowhurst J C, Zaug J M, Prakapenka V B and Oleynik I I 2017 High-Pressure Synthesis of a Pentazolate Salt Chemistry of Materials 29 (2), 735-741
46. Christe, K. O., Wilson, W. W., Sheehy, J. A., Boatz, J. A. N5+: A Novel Homoleptic Polynitrogen Ion as a High Energy Density Material Angew. Chem., Int. Ed. 2001, 40, 2947
47. Laniel D, Weck G, Gaiffe G, Garbarino G and P. Loubeyre 2018 High-Pressure Synthesized Lithium Pentazolate Compound Metastable under Ambient Conditions The Journal of Physical Chemistry Letters 9 (7), 1600-1604
48. Benchafia E M, Yao Z, Yuan G, Chou T, Piao H, Wang X and Iqbal Z 2017 Cubic gauche polymeric nitrogen under ambient conditions Nature Communications 8, Article number: 930
49. Wu, Z., Benchafia, E. M., Iqbal, Z. and Wang, X. (2014), N₈⁻ Polynitrogen Stabilized on Multi-Wall Carbon Nanotubes for Oxygen-Reduction Reactions at Ambient Conditions. Angew. Chem. Int. Ed., 53: 12555-12559
50. M. I. Eremets, R. J. Eremets, and H.-k. Mao, 2001 Semiconducting non-molecular nitrogen up to 240 GPa and its low-pressure stability, Nature, 411, 170-174 (2001).
51. Goncharov A F, Gregoryanz E, Mao H-K, Liu Z, and R J Hemley 2000 Optical Evidence for a Nonmolecular Phase of Nitrogen above 150 GPa Phys. Rev. Lett. 85, 1262
52. Gregoryanz E, Goncharov A F, Hemley R J and H-K Mao 2001 High-pressure amorphous nitrogen Phys. Rev. B 64, 052103
53. Gregoryanz E, Goncharov A F, Hemley R J, Mao H-K, Somayazulu M and G Shen 2002 Raman, infrared, and x-ray evidence for new phases of nitrogen at high pressures and temperatures Phys. Rev. B 66, 224108
54. Olijnyk H and A P Jephcoat 1999 Vibrational Dynamics of Isotopically Dilute Nitrogen to 104 GPa Phys. Rev. Lett. 83, 332
55. Seepersad Y, Pekker M, Shneider M N, Fridman A and Dobrynin D 2013 Investigation of positive and negative modes of nanosecond pulsed discharge in water and electrostriction model of initiation J. Phys. D: Appl. Phys. 46 355201
56. Lesaint 2016 Prebreakdown phenomena in liquids: propagation ‘modes’ and basic physical properties J. Phys. D: Appl. Phys. 49 144001
57. Laux C O 2002 Radiation and nonequilibrium collisional-radiative models Physico-Chemical Modeling of High Enthalpy and Plasma Flows (von Karman Institute Lecture Series 2002-07) ed D Fletcher et al (Belgium: Rhode-Saint-Genese)
58. I A Kossyi et al Kinetic scheme of the non-equilibrium discharge in nitrogen-oxygen mixtures, Plasma Sources Sci. Technol. 1 207, 1992
59. Peiris S M and T P Russell 2003 Photolysis of Compressed Sodium Azide (NaN3) as a Synthetic Pathway to Nitrogen Materials The Journal of Physical Chemistry A 2003 107 (6), 944-947

What is claimed is:

1. A method for generation of material in a liquid phase comprising a step of subjecting the liquid phase to a nanosecond-pulsed discharge plasma.

2. The method of claim 1, wherein the liquid phase comprises more than 50 wt % of liquid nitrogen.

3. The method of claim 1, wherein a solid phase is present in the liquid phase and said solid and liquid phases are subjected to the nanosecond-pulsed discharge plasma.

4. The method of claim 1, wherein the material that is generated is selected from the group consisting of neutral or ionic polymeric nitrogen, polymeric carbon monoxide and C₃N₄.

5. The method of claim 3, wherein the solid phase comprises an azide such as sodium azide.

6. The method of claim 1, wherein the discharge plasma is a spark discharge plasma.

7. The method of claim 1, wherein pulses are generated using a high voltage plasma source.

8. The method of claim 1, wherein pulses having an amplitude of 1-50 kV are used to ignite a spark discharge.

9. The method of claim 8, wherein the pulses are delivered from a power supply to a discharge gap between electrodes in contact with the liquid phase in a manner whereby the duration of the pulse is longer than the time it takes to propagate the pulse from the power supply to the discharge gap.

10. The method of claim 8, wherein the pulses are delivered from a power supply via a cable to a discharge chamber in a manner whereby there is an impedance mismatch between the discharge chamber and the cable and an impedance mismatch between the cable and the power supply.

11. The method of claim 2, wherein a solid phase is present in the liquid phase and said solid and liquid phases are subjected to the nanosecond-pulsed discharge plasma.

12. The method of claim 2, wherein the material that is generated is selected from the group consisting of neutral or ionic polymeric nitrogen, polymeric carbon monoxide and C₃N₄.

13. The method of claim 11, wherein the solid phase comprises an azide such as sodium azide.

14. The method of claim 2, wherein the discharge plasma is a spark discharge plasma.

15. The method of claim 2, wherein pulses are generated using a high voltage plasma source.

16. The method of claim 2, wherein pulses having an amplitude of 1-50 kV are used to ignite a spark discharge.

17. The method of claim 2, wherein the pulses are delivered from a power supply to a discharge gap between electrodes in contact with the liquid phase in a manner whereby the duration of the pulse is longer than the time it takes t propagate the pulse from the power supply to the discharge gap.

18. The method of claim 2, wherein the liquid phase comprises at least 90 wt % of liquid nitrogen.

19. The method of claim 2, wherein the liquid phase comprises at least about 99 wt % of liquid nitrogen.

20. The method of claim 2, wherein the liquid phase comprises less than about 1 wt. % of oxygen.
